(19) United States
(12) Patent Application Publication
(10) Pub. No.: US 2022/0318494 A1
(43) Pub. Date: Oct. 6, 2022

(54) APPARATUS AND METHOD FOR WRITING ELECTRONIC DOCUMENT BY INTERACTIVE TYPE AND DOCUMENT TYPE, METHOD FOR PROVIDING INTERACTIVE TYPE ELECTRONIC DOCUMENT

(71) Applicant: FORCS CO., LTD., Seoul (KR)

(72) Inventor: Mi Kyung PARK, Seoul (KR)

(21) Appl. No.: 17/640,257

(22) PCT Filed: May 6, 2020
(86) PCT No.: PCT/KR2020/005956

§ 371 Date: Mar. 3, 2022

(30) Foreign Application Priority Data
Nov. 22, 2019 (KR) 10-2019-0150961

(51) Int. Cl. G06F 40/186; G06F 3/16; G06F 3/04847; G06F 3/0488; G06F 40/174

(52) U.S. Cl. CPC G06F 40/186; G06F 3/167; G06F 3/04847; G06F 3/0488; G06F 40/174

(57) ABSTRACT

Provided is an apparatus and a method for writing an electronic document by an interactive type and a document type and a method for providing an electronic document which is written in an input mode. The interactive type and document type electronic document writing method includes extracting a plurality of input components corresponding to each entry field in a previously generated electronic document template, setting an interactive component for each of the extracted input components, and displaying an interface for any one of electronic document input modes including a document mode providing an electronic document template and an input mode providing an interactive component on a user terminal.

### BACKGROUND

### Field

The present disclosure relates to an apparatus and a method for writing an electronic document by an interactive type and a document type and a method for providing an interactive type electronic document.

### Description of the Related Art

In general, various types of documents are generated in the business area and the documents were written in a printed form in the related art, but recently, electronic documents and electronic signature services which generate various documents in the electronic form have been introduced to be utilized. The electronic documents and electronic signature services show a rapid growing trend in accordance with a paperless policy of the government.

Further, in accordance with the popularization of smart devices, user's experiences using voice based services have been consistently accumulated. Currently, most of the voice based services provide function associated with the daily life and are expected to expand to the business area of the companies in the future.

Accordingly, necessities of development of a technique or a system which generate an electronic document based on voice input or a technique and a system which control and manage an electronic document based on voice input are increasing.

Further, user's experience for various input units provided not only from the voice based services, but also from various smart devices is also consistently accumulated. Accordingly, when the electronic document is written, if the electronic document is written or managed while exchanging conversation through voice input/output together with a document type writing method which has been mainly utilized in the related art, it may be easier to write the electronic document associated with the task processing and manage the written electronic document.

A related art of the present disclosure is disclosed in Korean Registered Patent Publication No. 10-1705228.

### SUMMARY

The present disclosure has made an effort to solve the problem of the related art and an object thereof is to provide an apparatus and a method for writing an electronic document of an interactive type and a document type which provide both an interactive type writing mode in which an electronic document is written through a voice (utterance) of a user and a document type writing mode in which an electronic document is written in a touch input manner or a text input manner in a screen provided in the form of a document.

The present disclosure has made an effort to solve the problem of the related art and an object thereof is to provide a method for providing an electronic document which is written in an interactive type which sets an interactive component for an entry field in an electronic document template to write an electronic document while exchanging questions like the conversation.

The present disclosure has made an effort to solve the problem of the related art and an object thereof is to provide an apparatus and a method for writing an electronic document of an interactive type and a document type which are provided to switch an interactive writing mode and a document type writing mode by the user's convenience.

However, objects to be achieved by various embodiments of the present disclosure are not limited to the technical objects as described above and other technical objects may be present.

As a technical means to achieve the above-described technical object, according to an aspect of the present disclosure, an interactive type and document type electronic document writing method may include: extracting a plurality of input components corresponding to each entry field in a previously generated electronic document template; setting an interactive component for each of the extracted input components; and displaying an interface for any one of electronic document input modes including a document mode providing an electronic document template and an input mode providing an interactive component on a user terminal.

Further, the displaying may include displaying a first interface in which the electronic document template is embodied on the user terminal when a mode selection input for the document mode is received; and displaying a second interface to receive a response input associated with the interactive component on the user terminal when a mode selection input for the input mode is received.

Further, according to an exemplary embodiment of the present disclosure, the interactive type and document type electronic document writing method may include: writing an electronic document on the first interface based on a text type or a touch type response input; and writing an electronic document on the second interface based on a voice type response input.

Further, according to an exemplary embodiment of the present disclosure, the interactive type and document type electronic document writing method further may include: receiving a mode switching input to switch the electronic document input mode.

Further, when the mode switching input is received in the document mode, the electronic document input mode is switched to the input mode and when the mode switching input is input in the input mode, the electronic document input mode may be switched to the document mode.

Further, the setting of an interactive component may include: setting a layered structure for the plurality of input components, setting an entry order for each of the input component, and generating a question for each of the extracted input components.

Further, the writing of the electronic document on the second interface may include: outputting the question generated for each of the input components; and receiving the response input for the question and extracting and entering content data corresponding to the entry field based on the response input.

Further, in the outputting of the question, a plurality of questions for each of the input components may be sequentially output based on the entry order.

Further, the setting of an interactive component may include: setting a guidance which is displayed as a text type on the second interface.

Further, the generating of the question may include setting a synonym condition to extract the content data common to a plurality of phrases included in the response input; and setting a re-question condition to provide a re-question when the response input does not satisfy a predetermined condition.

In the meantime, according to another aspect of the present disclosure, a method for providing an electronic document which is written in an input mode may include extracting a plurality of input components corresponding to each entry field in a previously generated electronic document template; and setting an interactive component to complete the electronic document template based on user's voice input to each of the extracted input components.

In the meantime, according to another aspect of the present disclosure, an interactive type and document type electronic document writing apparatus may include: a component extracting unit configured to extract a plurality of input components corresponding to each entry field in a previously generated electronic document template; a conversation setting unit configured to set an interactive component for each of the extracted input components; and a display unit configured to display an interface for any one of electronic document input modes including a document mode providing an electronic document template and an input mode providing an interactive component.

Further, the display unit may display a first interface in which the electronic document template is embodied when a mode selection input for the document mode is received and display a second interface to receive a response input associated with the interactive component when a mode selection input for the input mode is received.

Further, according to the exemplary embodiment of the present disclosure, the interactive type and document type electronic document writing apparatus may include a document writing unit configured to write an electronic document on the first interface based on a text type or a touch type response input or write an electronic document on the second interface based on a voice type response input.

Further, the conversation setting unit may include: an aligning unit configured to set a layered structure for the plurality of input components and set an entry order for each of the input component; and a question generating unit configured to generate a question for each of the extracted input components.

Further, the conversation setting unit may include: a condition setting unit configured to set a synonym condition to extract common content data for a plurality of phrases included in the response input and set a re-question condition to provide a re-question when the response input does not satisfy a predetermined condition.

Further, according to an exemplary embodiment of the present disclosure, the interactive type and document type electronic document writing apparatus may include: a form generating unit configured to generate the electronic document template to include a plurality of input components.

The above-described solving means are merely illustrative but should not be construed as limiting the present disclosure. In addition to the above-described embodiments, additional embodiments may be further provided in the drawings and the detailed description of the present disclosure.

According to the object of the present disclosure, it is possible to provide an apparatus and a method for writing an electronic document of an interactive type and a document type which provide both an interactive type writing mode in which an electronic document is written through a voice (utterance) of a user and a document type writing mode in which an electronic document is written in a touch input manner or a text input manner in a screen provided in the form of a document.

According to the object of the present disclosure, it is possible to provide a method for providing an electronic document which is written in an interactive type which sets an interactive component for an entry field in an electronic document template to write an electronic document while exchanging questions like the conversation.

According to the object of the present disclosure, it is possible to provide an interactive type or document type electronic document writing apparatus and method which are provided to switch an interactive writing mode and a document type writing mode by the user's convenience.

However, the effect which can be achieved by the present disclosure is not limited to the above-described effects, there may be another effects.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram of an interactive type and document type electronic document writing system according to an exemplary embodiment of the present disclosure;

FIG. 2 is a conceptual view for explaining a document mode and an input mode according to an exemplary embodiment of the present disclosure;

FIG. 3 is a view illustrating a UI for setting an interactive component according to an exemplary embodiment of the present disclosure;

FIGS. 4A to 4I are views illustrating an interactive component setting UI according to a type of an input component according to an exemplary embodiment of the present disclosure;

FIG. 5 is a view for explaining a process of generating an electronic document template according to an exemplary embodiment of the present disclosure;

FIG. 6 is a schematic diagram of an interactive type and document type electronic document writing apparatus according to an exemplary embodiment of the present disclosure;

FIG. 7 is a schematic diagram of a conversation setting unit according to an exemplary embodiment of the present disclosure;

FIG. 8 is an operation flowchart of an interactive type and document type electronic document writing method according to an exemplary embodiment of the present disclosure; and

FIG. 9 is an operation flowchart of a method for providing an electronic document which is written in an interactive type according to an exemplary embodiment of the present disclosure.

### DETAILED DESCRIPTION OF THE EMBODIMENT

Hereinafter, the present disclosure will be described more fully hereinafter with reference to the accompanying drawings, in which exemplary embodiments of the present disclosure are shown. However, the present disclosure may be realized in various different forms, and is not limited to the embodiments described herein. Accordingly, in order to clearly explain the present disclosure in the drawings, portions not related to the description are omitted. Like reference numerals designate like elements throughout the specification.

Throughout this specification and the claims that follow, when it is described that an element is “coupled” to another element, the element may be “directly coupled” to the other element or “electrically coupled” or “indirectly coupled” to the other element through a third element.

Through the specification of the present disclosure, when one member is located “on”, “above”, “on an upper portion”, “below”, “under”, and “on a lower portion” of the other member, the member may be adjacent to the other member or a third member may be disposed between the above two members.

In the specification of the present disclosure, unless explicitly described to the contrary, the word “comprise” and variations such as “comprises” or “comprising”, will be understood to imply the inclusion of stated elements but not the exclusion of any other elements.

The present disclosure relates to an apparatus and a method for writing an electronic document by interactive type and a document type and a method for providing an interactive type electronic document.

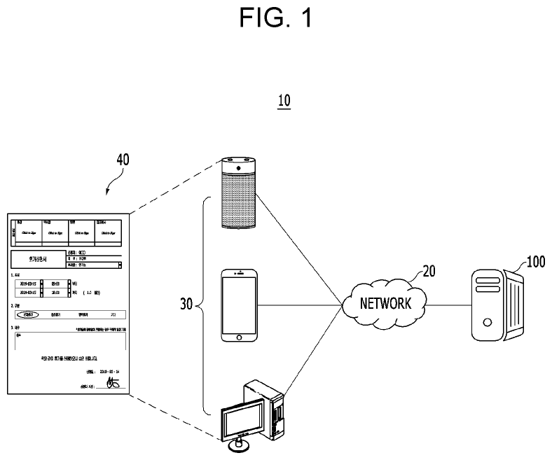

FIG. 1 is a schematic diagram of an interactive type and document type electronic document writing system according to an exemplary embodiment of the present disclosure.

Referring to FIG. 1, the interactive type and document type electronic document writing system 10 according to the exemplary embodiment of the present disclosure may include a user terminal 30 and an interactive type and document type electronic document writing apparatus 100 (hereinafter, referred to as “electronic document writing apparatus 100”). Specifically, referring to FIG. 1, the interactive type and document type electronic document writing system 10 according to the exemplary embodiment of the present disclosure may refer to a system which writes an electronic document 40 in the user terminal 30 by interacting with the electronic document writing apparatus 100 and provides (displays) the written electronic document 40 to the user terminal 30. However, it is not limited thereto and according to the exemplary embodiment of the present disclosure, the electronic document writing apparatus 100 may be a server or a device which is the same as the user terminal 30.

The user terminal 30 and the electronic document writing apparatus 100 may communicate with each other via a network 20. The network 20 means a connection structure which allows information exchange between nodes such as terminals or servers. Examples of the network 200 include 3^{rd} generation partnership project (3GPP) network, a long term evolution network (LTE), a 5G network, a world interoperability for microwave access (WIMAX) network, Internet, a local area network (LAN), Wireless Local Area Network (Wireless LAN), Wide Area Network (WAN), a personal area network (PAN), a Wi-Fi network, a Bluetooth network, a satellite broadcasting network, an analog broadcasting network, and a digital multimedia broadcasting (DMB) network, but are not limited thereto.

For example, the user terminal 30 may include all kinds of wireless communication devices such as a smart phone, a smart pad, a tablet PC, a personal communication system (PCS), a global system for mobile communication (GSM), a personal digital cellular (PDC), a personal handyphone system (PHS), a personal digital assistant (PDA), an international mobile telecommunication (IMT)-2000, code division multiple access (CDMA)-2000, W-code division multiple access (W-CDMA), and a wireless broadband internet (Wibro) terminal.

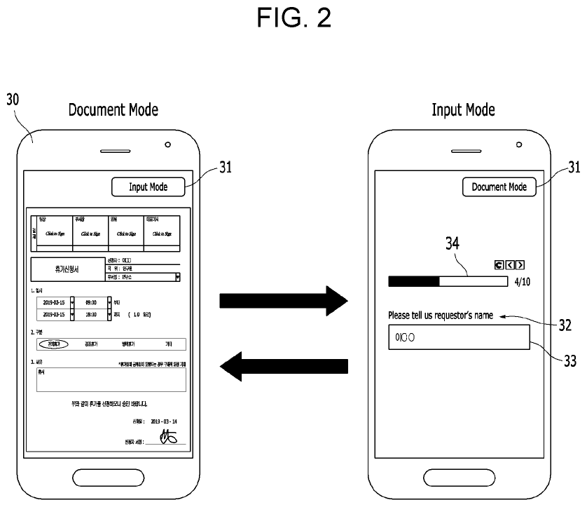

FIG. 2 is a conceptual view for explaining a document mode and an input mode according to an exemplary embodiment of the present disclosure.

Referring to FIG. 2, in the document type writing mode (document mode) of the present disclosure, a previously generated electronic document template is displayed on a display of the user terminal 30. A user of the user terminal 30 selects an input area for an entry field to be input with respect to the displayed electronic document template and fills out a plurality of entry fields in the electronic document template by applying a text type or a touch type response input to the selected input area to write the electronic document. Here, a screen (interface) which is provided to the display of the user terminal 30 in accordance with a document mode may be referred to as a first interface in the following description.

Further, referring to FIG. 2, in an interactive type writing mode (input mode), interactive components set to each of input components included in the previously generated electronic document template are displayed on the display of the user terminal 30 and the user of the user terminal 30 may fill out the plurality of entry fields in the electronic document template by applying a voice type response input for the question included in the interactive component to write the electronic document. Here, a screen (interface) which is provided to the display of the user terminal 30 in accordance with the input mode may be referred to as a second interface in the following description.

Further, according to the exemplary embodiment of the present disclosure, in the second interface, an area 32 in which a question included in the set interactive component is displayed as a text, an area 33 in which a voice type response input applied by the user of the user terminal 30 is subject to a speech-to-text process to be recognized and displayed, an area in which the total number of interactive components which need to be input to complete the corresponding electronic document template and an order (in FIG. 2, an area displayed by “4/10”) of an interactive component which is being currently provided are displayed, and a display bar 34 which represents a current input progress status based on the total number of interactive components which needs to be input to complete the corresponding electronic document template may be displayed, but is not limited thereto. As another example, in the second interface, a question for an interactive component which is currently being provided is displayed in the center thereof, a question for an interactive component which has been completely input before providing the question for the current interactive component is displayed in an upper portion, and a question for an interactive component to be provided after providing the question of the current interactive component is displayed in a lower portion.

Further, according to the exemplary embodiment of the present disclosure, in the first interface and the second interface, a mode switching button 31 to receive a mode switching input to be described below may be displayed. With regard to this, when the user of the user terminal 30 applies an input to touch or click the mode switching button 31 while writing a predetermined electronic document (in other words, a mode switching input is applied), in the document mode, the electronic document input mode is switched to the input mode and in contrast, in the input mode, the electronic document input mode may be switched to the document mode. Here, when the electronic document input mode is switched, it is understood that the interface displayed on the display of the user terminal 30 is switched to the first interface or the second interface, but is not limited thereto. As another example, when the user of the user terminal 30 applies an input to click or touch the mode switching button 31 while writing a predetermined electronic document (in other words, applies a mode switching input), a separate pop-up window is activated so that the first interface or the second interface may be additionally expressed with respect to the current interface. As yet another example, when the user of the user terminal 30 applies an input to click or touch the mode switching button 31 while writing a predetermined electronic document, the first interface or the second interface may be implemented to be expressed to be overlaid with the part of the current interface in an upper area (in other words, an upper layer) or a lower area (in other words, a lower layer) of the interface which is being currently displayed.

Further, according to the exemplary embodiment of the present disclosure, the mode switching input to switch the input mode and the document mode may be applied in the form of a voice input. Specifically, according to the exemplary embodiment of the present disclosure, when a voice input including a content requesting to change the mode is applied to the user terminal 30 as a mode switching input while the user writes a predetermined electronic document in the input mode or the document mode, the electronic document writing apparatus 100 of the present disclosure may be implemented to switch the input mode or the document mode.

According to the exemplary embodiment of the present disclosure, the electronic document writing apparatus 100 prepares the first interface and the second interface on the display of the user terminal 30 to be switched into each other and mixes a web based implementation and native based implementation associated with an application program or an application which is executed when the electronic document is actually written in the user terminal 30 so as to complete one electronic document template (in other words, data included in the response input is synchronized regardless of the interface type) by reflecting a response input applied from the first interface and a response input applied from the second interface. According to the exemplary embodiment of the present disclosure, the interface implementation for mode switching and the second interface implementation in the application program or the application executed in the user terminal are designed based on the web and the first interface implementation in which the electronic document template is displayed may be designed based on the Native. Accordingly, according to the present disclosure, when in the user terminal 30, the electronic document is written based on the response input applied by the user, if a form is dynamically changed by a mode selection input or a mode switching input or a predetermined input component value is changed in a specific mode, the changed input component value may be changed in the same way in the other mode.

Hereinafter, the specific operation and function of the electronic document writing apparatus 100 will be described in detail.

The electronic document writing apparatus 100 may extract a plurality of input components corresponding to entry fields in the previously generated electronic document template.

Further, the electronic document writing apparatus 100 may set an interactive component for each of the extracted input components. Specifically, the electronic document writing apparatus 100 may set a layered structure for the plurality of extracted input components. For example, the electronic document writing apparatus 100 may generate a high level component group including a plurality of input components.

Further, the electronic document writing apparatus 100 may set an entry order for the input components. According to the exemplary embodiment of the present disclosure, an order of questions to be provided to a user (for example, an electronic document writer) in the input mode may be determined according to the entry order determined for each input component.

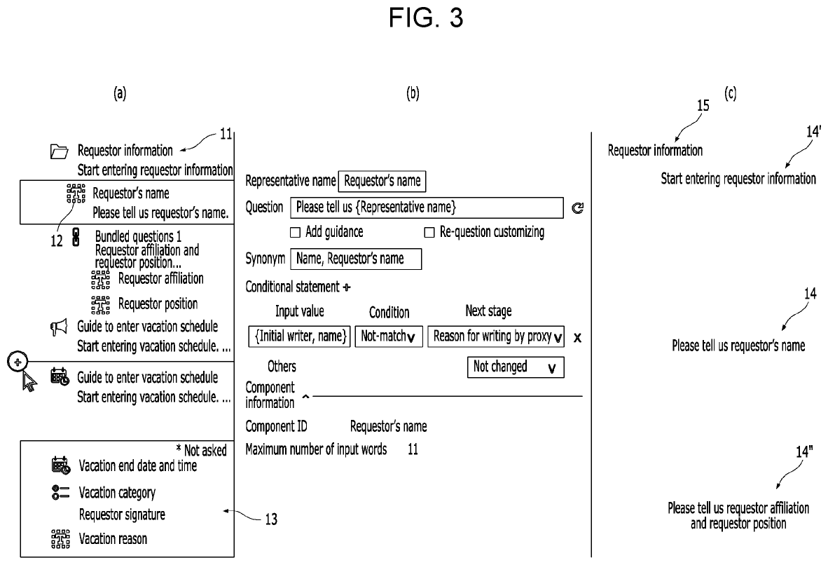

Further, the electronic document writing apparatus 100 may generate questions for each of the extracted input components. Here, the questions for each of the input component may refer to questions inducing a response input of the user to include content data to be input to the corresponding entry field, with respect to the corresponding input component. For example, referring to FIG. 3, a representative name of the input component corresponding to an entry field “requestor's name” is set to “requestor's name” and a question set for the corresponding input component may be determined to be “Please tell us {representative name}.”, that is, “Please tell us requestor's name”, but is not limited thereto.

Further, the electronic document writing apparatus 100 may set a guidance displayed as a text type on the second interface.

Further, when a question for the input component is generated, the electronic document writing apparatus 100 may set a synonym condition to extract common content data for a plurality of phrases included in the response input.

Further, when the response input does not satisfy the predetermined condition, the electronic document writing apparatus 100 may set a re-question condition to provide a re-question.

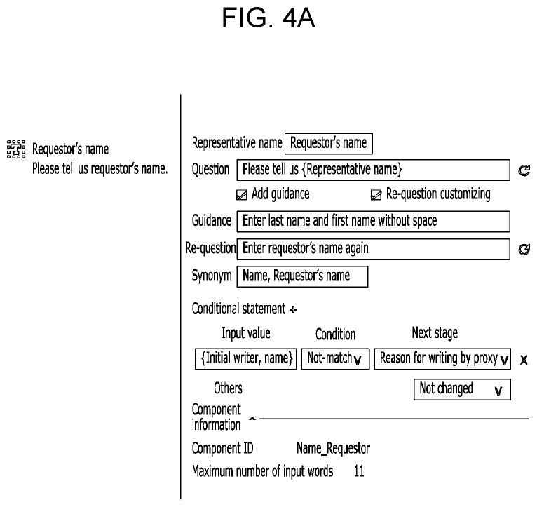

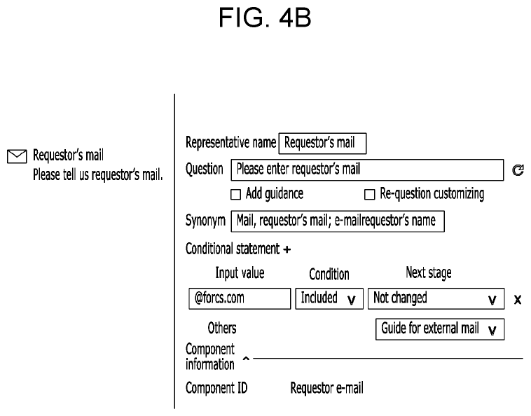

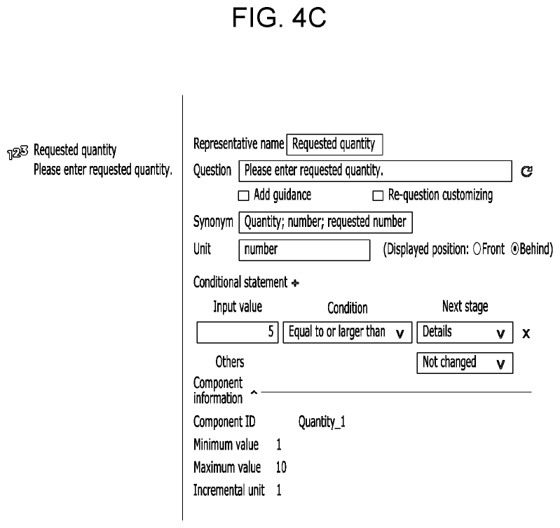

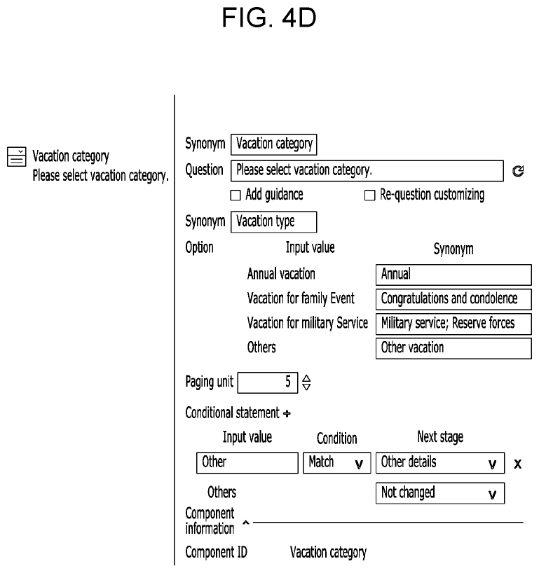

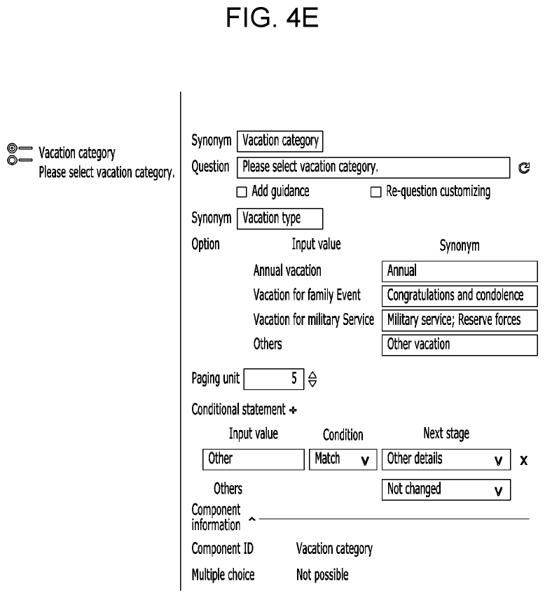

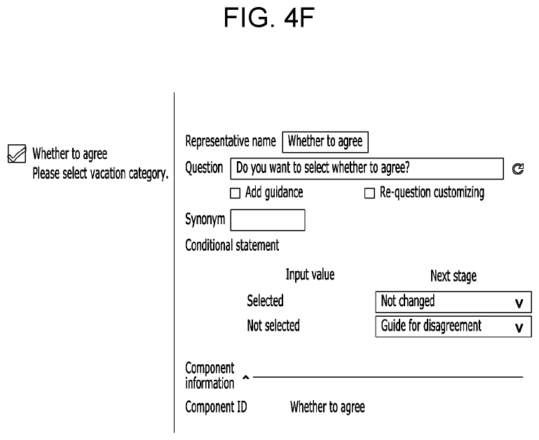

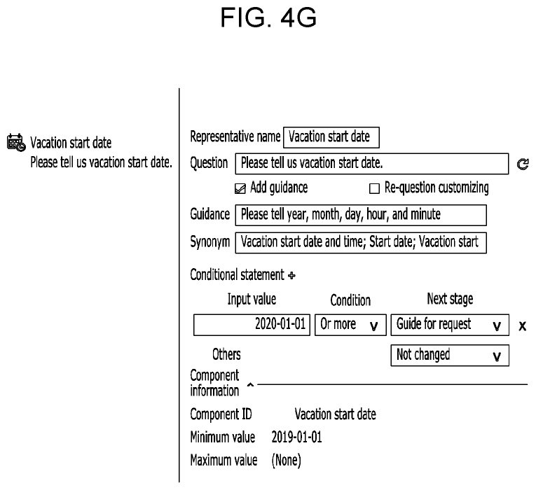

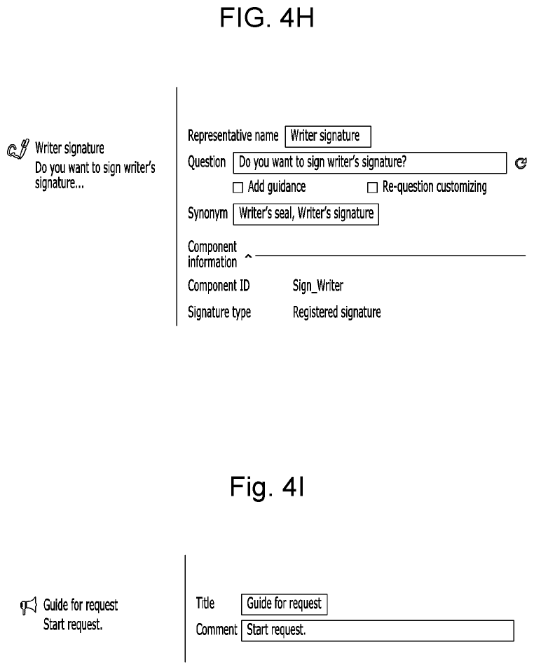

The setting of the interactive component for the input component described above will be described in detail with reference to FIGS. 3 to 4I to be described below.

Further, the electronic document writing apparatus 100 may display an interface for any one of electronic document input modes including a document mode providing an electronic document template and an input mode providing a set interactive component on the user terminal. Specifically, when the mode selection input for the document mode is received, the electronic document writing apparatus 100 may display the first interface in which an electronic document template is embodied, on the user terminal 30. Further, when the mode selection input for the input mode is received, the electronic document writing apparatus 100 may display the second interface for receiving a response input associated with the interactive component, on the user terminal 30.

Here, the mode selection input may be understood as a user input applied to select an electronic document to be written by the user of the user terminal 30 in the input mode or the document mode, and according to an exemplary embodiment, the mode selection input may be applied in an initial stage of the writing (for example, at a time when the writing of the electronic document starts), but is not limited thereto. According to the exemplary embodiment, when a separate mode selection input is not applied, the electronic document writing apparatus 100 may be implemented to basically provide an interface for any one of the document mode and the input mode. When the mode selection input is not applied, the initial interface provided to the display of the user terminal 30 may be determined by a separate user's setting according to the exemplary embodiment.

Further, the electronic document writing apparatus 100 may write the electronic document on the first interface based on the text type or touch type response input. Here, when the electronic document is written on the first interface, it may mean that the response input (including a text type or a touch type) of the user applied in the above-described document mode is received from the user terminal 30 and the entry field for each of the corresponding electronic document template is input based on the received response input.

Further, the electronic document writing apparatus 100 may write the electronic document on the second interface based on the voice type response input. Here, when the electronic document is written on the second interface, it may mean that the response input (including a voice type) of the user applied in the input mode is received from the user terminal 30 and content data is input to the entry field for each of the corresponding electronic document template based on the received response input.

Further, according to the exemplary embodiment of the present disclosure, the electronic document writing apparatus 100 may output a question generated for each of the input components so as to write the electronic document on the second interface (in other words, in the input mode). Here, when the question is output, the corresponding question may be output as a voice type in the user terminal 30, but it is not limited thereto so that the corresponding question may be output as a text type or output as both a voice type and a text type. Further, the electronic document writing apparatus 100 may receive the response input for the question and extract and enter the content data corresponding to the entry field based on the response input.

Specifically, according to the exemplary embodiment of the present disclosure, the electronic document writing apparatus 100 analyzes the voice type response input in the unit of key and value to extract the content data corresponding to the entry field and enter the extracted content data in the electronic document template. Here, the key may also be referred to as a field key and the value may also be referred to as a field value.

According to the exemplary embodiment of the present disclosure, the key may refer to an input component associated with the entry field to be input by the user on the electronic document template to complete one electronic document template. According to the exemplary embodiment of the present disclosure, the input component may also be referred to as intention data.

When the electronic document template is a request for vacation, the intention data according to the exemplary embodiment of the present disclosure may include “(vacation) date”, “(vacation) category”, and “reason (of vacation)” which need to be input by the user to complete the corresponding electronic document template.

The electronic document writing apparatus 100 according to the exemplary embodiment of the present disclosure extracts a part which has a similarity larger than or equal to the electronic document entry field from the response input to acquire the key (intention data).

Further, according to an exemplary embodiment of the present disclosure, the electronic document writing apparatus 100 may utilize a Levenshtein distance algorithm to determine a point at which the intention data starts from the response input of the user. A predicted position of the intention data is specified by the algorithm and an edit distance between the electronic document entry field and a portion which is estimated as the intention data is calculated by sequentially moving the predicted position one by one to determine a point at which the edit distance is minimum as a point that the intention data starts.

Further, according to the exemplary embodiment of the present disclosure, the electronic document writing apparatus 100 may extract source content data corresponding to the intention data. Specifically, the electronic document writing apparatus 100 may extract a portion before a starting point of the N+1-th intention data from an ending point of N-th intention data among the response voice input as source content data corresponding to the N-th intention data.

Further, according to the exemplary embodiment of the present disclosure, it is understood that the value refers to the source content data.

Further, according to the exemplary embodiment of the present disclosure, when the N-th intention data is the last intention data in the response voice input, the electronic document writing apparatus 100 may extract the portion from the ending point of the N-th intention data to the last of the response voice input as source content data corresponding to the N-th intention data.

The source content data may include a part of utterance which corresponds to the intention data and is not cleansed, together with the content data to be input for the electronic document entry field and is finally, processed as the content data by the electronic document writing apparatus 100 to be entered in the entry field in the electronic document template.

Hereinafter, a process of processing the source content data derived from the response input to content data to be actually entered in the electronic document entry field by the electronic document writing apparatus 100 will be described in more detail.

Even though not illustrated in the drawings, for the purpose of processing to the content data, the electronic document writing apparatus 100 may include a postposition processing unit, a morpheme analyzing unit, and a form converting unit.

The postposition processing unit may process by determining whether a first segment of the source content data is a postposition. At this time, when the first segment of the source content data is a postposition, the postposition processing unit may delete the corresponding segment.

The morpheme analyzing unit may combine the remaining segments excluding the first segment. Further, the morpheme analyzing unit may perform the morpheme analysis on a last segment of the source content data which is primarily processed by the postposition processing unit. Further, the morpheme analyzing unit may detect the morpheme analysis result in a reverse direction to detect a full morpheme.

When the detected full morpheme is not a nominal form, the form converting unit may convert the detected full morpheme into a nominal form. For example, the form converting unit may perform the conversion into the nominal form by combining “-ness” or “-t(s)ion” after the full morpheme of a predicate (verb or adjective) form. According to the exemplary embodiment of the present disclosure, the form converting unit may convert the detected full morpheme in consideration of a type of the detected full morpheme. For example, when the detected full morpheme is a “text type”, if the detected full morpheme is not a nominal form as described above, the detected full morpheme may be converted into a nominal form, and as another example, if the detected full morpheme is a “date type”, the detected full morpheme may be converted into a date form (for example, year-month-day). Specifically, when the detected full morpheme is “today”, “date type” is identified as a full morpheme to enter a date of the corresponding day. As yet another example, when the detected full morpheme is a “number type”, number information itself may be entered without performing additional conversion.

Further, according to the exemplary embodiment of the present disclosure, when the format of the corresponding electronic document entry item is not appropriate to be filled with the detected full morpheme, such as a combo box, a check box, or a radio button, a combo box, a check box, or a radio button which is the most approximate to the contents included in the detected full morpheme may be selected on the basis of the above-described Levenshtein distance algorithm.

According to the exemplary embodiment of the present disclosure, the source content data which has been completely converted by the form converting unit may be fixed as the content data to be finally entered in the electronic document template.

Further, the electronic document writing apparatus 100 may receive a mode switching input to switch an electronic document input mode. According to the exemplary embodiment of the present disclosure, when the mode switching input is received in the document mode, the electronic document input mode is switched to the input mode and in contrast, when the mode switching input is input in the input mode, the electronic document input mode may be switched to the document mode. As described above, according to the present disclosure, a plurality of electronic document input modes is provided to complete one electronic document 40 and the electronic document input mode may be freely switched as needed while writing the electronic document based on one mode.

Hereinafter, a process of setting an interactive component according to an exemplary embodiment of the present disclosure will be described with reference to FIGS. 3 to 4I.

FIG. 3 is a view illustrating a UI for setting an interactive component according to an exemplary embodiment of the present disclosure.

Referring to FIG. 3, the electronic document writing apparatus 100 may display a user interface (UI) to set an interactive component. Further, referring to FIG. 3, the user interface (UI) for setting the interactive component may include a component tree area (a), a detailed setting area for every component (b), and a preview area (c). Further, referring to FIG. 3, the above-described three areas ((a) area to (c) area) are disposed in three-layered layouts which are partitioned to be disposed side by side in a lateral direction, but it is not limited thereto. According to the exemplary embodiment, the UI for setting an interactive component may be implemented to display only a part of the (a) area to (c) area based on a display size of the electronic document writing apparatus 100 on which the corresponding UI is displayed or a separate terminal (not illustrated) in which the interactive component setting is performed.

In the component tree area (a), a plurality of input components extracted from the corresponding electronic document template is arranged. In each of the input components, a component type 12 may be displayed by a predetermined icon. Further, a plurality of input components which corresponds to a similar field or belongs to the same higher level components may be grouped, and in the component tree area (a), a group name 11 which represents the plurality of grouped input components may be displayed. Further, in the component tree area (a), an unprocessed list 13 may be displayed to identify input components in which the interactive component setting has not been completed or the interactive component setting is not necessary, among the input components for the corresponding electronic document template.

With regard to this, the electronic document writing apparatus 100 may receive an input to select any one of the plurality of input components arranged in the component tree area (a) to activate the detailed setting area (b) for every component with respect to the selected input component. Further, the electronic document writing apparatus 100 rearranges the order of the plurality of input components arranged in the component tree area (a) based on the user input or may generate a component group including predetermined input components. For example, the user input to set an order for the input component or the user input to generate the component group may be applied by a drag-and-drop manner. For example, referring to FIG. 3, the component group “requestor information” may include a plurality of input components corresponding to a “requestor's name”, “requestor affiliation”, and “requestor position”. According to the exemplary embodiment, when a user input to select between two input components (at least one is a component group) which are continuously disposed up and down in parallel is applied, an “add button” may be expressed. Further, when a user input to select (touch or click) the expressed add button is applied, the electronic document writing apparatus 100 may display a UI to newly add a group, a notice, and a bundled question.

The detailed setting area (b) for every component may be understood as an area in which a detailed question setting is performed for the selected input component. Referring to FIG. 3, the detailed setting area (b) for every component may include a representative name tab, a question tab, a synonym condition (“synonym”) tab, and a re-question condition (“conditional statement”) tab, but is not limited thereto. Specifically, various tabs provided in the detailed setting area (b) for every component may be determined based on a type of the corresponding input component to be different, which will be described below with reference to FIGS. 4A to 4I.

In the preview area (c), after determining an interactive component for the corresponding input component based on the content determined in the detailed setting area (b) for every current component, when the corresponding interactive component is displayed as a second interface in the user terminal 30 when the electronic document is written, a preview screen which will be seen by the user of the user terminal 30 may be displayed. According to the exemplary embodiment of the present disclosure, in the preview area (c), a question included in the interactive component associated with the input component whose detailed setting is currently being performed is displayed (14) at the center. A question included in the interactive component associated with the input component which precedes the input component displayed at the center according to the set entry order is displayed (14′) in an upper portion. Further, a question included in the interactive component associated with the input component following the input component displayed at the center in the set entry order is displayed (14″) in a lower portion.

Further, referring to FIG. 3, in the preview area (c), when there is a higher level component group including input components which are currently being set, the name of the corresponding component group may be displayed (15). Further, according to the exemplary embodiment of the present disclosure, previous question displaying (14′) and subsequent question displaying (14″) may be displayed to be blurred more than the current question displaying (14) on the display of the electronic document writing apparatus 100 or the user terminal 30.

FIGS. 4A to 4I are views illustrating an interactive component setting UI according to a type of an input component according to an exemplary embodiment of the present disclosure.

According to the exemplary embodiment of the present disclosure, a type of an input component in the electronic document template may include a text, a mail, a number, a combo, a radio, check, date, and signature, but is not limited thereto. The type of input component may include various types in consideration of the entry field which may be input in the electronic document template according to the exemplary embodiment of the present disclosure.

Specifically, FIG. 4A illustrates an interactive component setting user interface (UI) for a text type input component, FIG. 4B illustrates an interactive component setting UI for a mail type input component, FIG. 4C illustrates an interactive component setting UI for a number type input component, FIG. 4D illustrates an interactive component setting UI for a combo type input component, FIG. 4E illustrates an interactive component setting UI for a radio type input component, FIG. 4F illustrates an interactive component setting UI for a check type input component, FIG. 4G illustrates an interactive component setting UI for a date type input component, FIG. 4H illustrates an interactive component setting UI for a signature type input component, and FIG. 4I illustrates a UI for setting a guidance provided by a voice.

Referring to FIG. 4A, the interactive component setting UI for the input component may include a left region including a type “T” of the input component, a representative name (“requestor's name”) of the input component, and a question (for example, “Please tell us requestor's name.”) determined for the corresponding input component and a right region for various detailed settings. In the right region, a representative name setting tab, a question setting tab, a notice setting tab, a condition setting tab, a synonym condition setting tab, a condition setting tab, and a component information display tab may be displayed. The electronic document writing apparatus 100 receives a user input for each tab in the right region and may complete the interactive component setting for the corresponding input component based on the received user input.

Specifically, referring to FIG. 4A, when a separate user input is not applied, the question setting tab (“question”) may provide a question for directly asking a representative name such as “please tell us {representative name}.” as a default for the corresponding input component. Further, the guidance setting tab (“guidance”) may be provided to set a phrase which is displayed only as a text type on the second display without expressing a voice. Further, the synonym condition setting tab (“synonym”) may be provide to add various expressions indicating the corresponding input component from modification, field selection, a bundled answer for the entered content data. The condition setting tab (“conditional statement”) is provided to set different subsequent steps after the question for the corresponding input component according to the content of the response input of the user. For example, referring to FIG. 4A, when a name of the initial writer does not match a name included in the response input of the user, the electronic document writing apparatus 100 may be implemented to determine that the writer does not match content data applied for the corresponding input component (requestor's name) and proceed a process for requesting a reason for writing by proxy. According to the exemplary embodiment of the present disclosure, a condition field of the “conditional statement” tab for the text type input component may include “match/not match/include.” Further, the component information display tab (“component information”) may include component ID information and information of maximum number of input words, and the component ID information and the information of maximum number of input words may be set for the corresponding input component in a step of generating an electronic document template. The interactive component setting method for the above-described input component may be applied to FIGS. 4B to 4H to be described below in the same way.

Referring to FIG. 4B, when the condition for the mail type input component is set, if a mail address included in the response input of the user is an address other than a predetermined domain address (for example, @forcs.com in FIG. 4B), the electronic document writing apparatus 100 may set to proceed to a step of guiding an external mail. Based on this setting, during the writing of the actual electronic document, if the mail address included in the response input of the user does not include a predetermined domain address, the step of guiding an external mail may be performed.

Referring to FIG. 4C, when the condition for a number type input component is set, if a figure included in the response input of the user is within a predetermined range (for example, 5 or larger in FIG. 4B), it may be set to proceed a subsequent step (for example, a detail step). Based on this setting, during the writing of the actual electronic document, a predetermined subsequent step in which a figure value included in the response input of the user is within a predetermined range may be performed. Further, according to the exemplary embodiment of the present disclosure, the condition field of the condition setting tab for the number type input component may include match/equal to or larger than/equal to or less than/larger than/less than.

Referring to FIG. 4D, the electronic document writing apparatus 100 may display an option setting tab (“option”) in the interactive component setting UI for a combo type input component. When the actual electronic document is written according to the setting in the option setting tab, any one of a plurality of predetermined input values may be selected as content data from a response input of the user. Further, in the interactive component setting UI for the combo type input component, a paging unit setting tab (“paging unit”) may be displayed. When the actual electronic document is written according to the setting in the paging unit setting tab, the number of option input values represented on one screen on the second interface may be determined.

Referring to FIG. 4E, unlike the combo type input component, the radio type input component may be implemented such that multiple choices for a plurality of input values are not allowed.

Referring to FIG. 4F, a subsequent step when a response input for selecting a check type input component is applied (in other words, a corresponding entry field is checked) and a subsequent step when a response input that the input component is not selected (in other words, a corresponding entry field is not checked) may be determined to be different by the setting of the condition setting tab.

Referring to FIG. 4G, when a setting of the condition setting tab may be performed to proceed different subsequent steps based on a date value included in the response input for the date type input component. Further, according to the exemplary embodiment of the present disclosure, the condition field of the condition setting tab for the date type input component may include match/equal to or larger than/equal to or less than/larger than/less than.

Referring to FIG. 4H, when the setting for the signature type input component is performed, after outputting a question (for example, “do you want to sign the writer's signature?”) included in the interactive component for the corresponding input component when the actual electronic document is written, a signature input window for receiving a signature input is displayed on the display of the user terminal 30.

Referring to FIG. 4I, the electronic document writing apparatus 100 may set a guidance phrase to perform smooth conversation with a user and receive a response input during the writing of the electronic document, separately from the entry field of the electronic document template based on the user input.

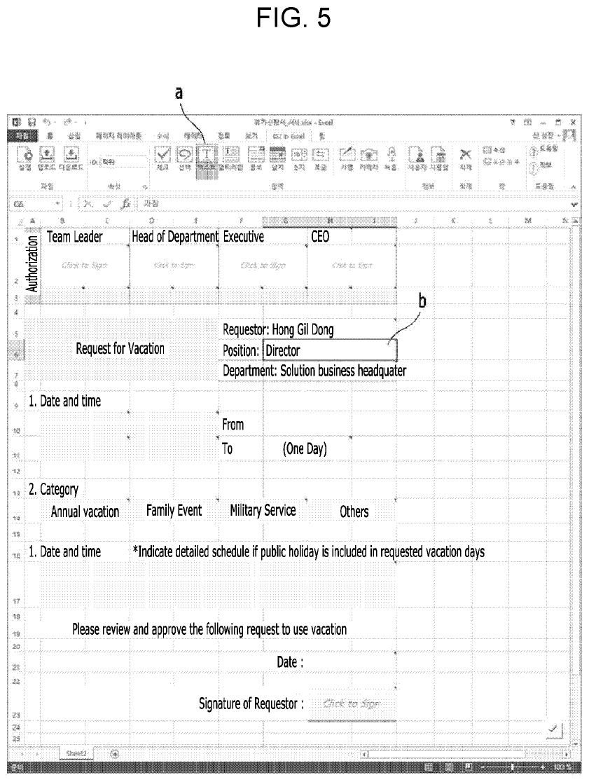

FIG. 5 is a view for explaining a process of generating an electronic document template according to an exemplary embodiment of the present disclosure.

Referring to FIG. 5, the electronic document writing apparatus 100 may generate an electronic document template to include a plurality of input components. Specifically, referring to FIG. 5, the electronic document writing apparatus 100 may generate an electronic document template by utilizing an Office based document platform such as Excel document. Specifically, referring to FIG. 5, the electronic document writing apparatus 100 may receive a user input (a) for a component type for an input component assigned to a predetermined cell among cells in a form including a plurality of rows and a plurality of columns and a user input (b) for sell selection to generate an input component in the electronic document template. The electronic document template generating process illustrated in FIG. 5 may be performed by the electronic document writing apparatus 100 prior to the above-described interactive component setting.

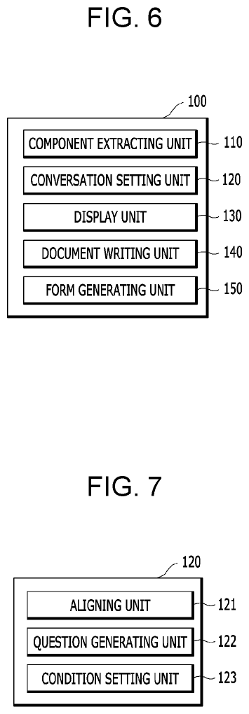

FIG. 6 is a schematic diagram of an interactive type and a document type electronic document writing apparatus according to an exemplary embodiment of the present disclosure.

Referring to FIG. 6, the electronic document writing apparatus 100 may include a component extracting unit 110, a conversation setting unit 120, a display unit 130, a document writing unit 140, and a form generating unit 150.

The component extracting unit 110 may extract a plurality of input components corresponding to entry fields in the previously generated electronic document template. Here, the previously generated electronic document template may refer to an electronic document template which is generated by the form generating unit 150 to be described below.

The conversation setting unit 120 may set an interactive component for each of the extracted input components.

The display unit 130 may display an interface for any one of electronic document input modes including a document mode providing an electronic document template and an input mode providing an interactive component.

Specifically, when the mode selection input for the document mode is received, the display unit 130 may display the first interface in which an electronic document template is embodied. Further, when the mode selection input for the input mode is received, the display unit 130 may display the second interface for receiving a response input associated with the interactive component. According to the exemplary embodiment of the present disclosure, the display unit 130 may include a web based UI module to display the second interface for the interactive component.

The document writing unit 140 may write the electronic document on the first interface based on a text type or a touch type response input or write the electronic document on the second interface based on a voice type response input. According to the exemplary embodiment of the present disclosure, the document writing unit 140 may include a natural language processing module (not illustrated) to extract content data which is actually input in an entry field of the electronic document template from the response input which is input as a voice type. Further, according to the exemplary embodiment of the present disclosure, the document writing unit 140 may include a native based speech-to-text (STT) module and text-to-speech (TTS) module to output the generated question as a voice type and process a voice type response input of the user corresponding to the question.

The form generating unit 150 may generate an electronic document template to include a plurality of input components.

Further, the electronic document writing apparatus 100 may include a user input receiving unit (not illustrated) which receives various user inputs to determine details of the electronic document template and a detailed setting for the interactive component when the above-described electronic document template is generated or the interactive component is set.

Further, the electronic document writing apparatus 100 may include an engine module (not illustrated) to manage a plurality of input components for various electronic document templates and an interactive component set for the input component.

Further, the electronic document writing apparatus 100 may include a hybrid module (not illustrated) to use a web based implementation and a native based implementation together in the application program or the application installed to write the electronic document in the user terminal 30, as described above.

FIG. 7 is a schematic diagram of a conversation setting unit according to an exemplary embodiment of the present disclosure.

Referring to FIG. 7, the conversation setting unit 120 may include an aligning unit 121, a question generating unit 122, and a condition setting unit 123.

The aligning unit 121 may set a layered structure for the plurality of input components. Further, the aligning unit 121 may set an entry order for each of the extracted input components.

The question generating unit 122 may generate a question for each of the extracted input components.

The condition setting unit 123 may set a synonym condition to extract common content data for a plurality of phrases included in the response input. Further, when the response input does not satisfy the predetermined condition, the condition setting unit 123 may set a re-question condition to provide a re-question.

Hereinafter, an operation flow of the present disclosure will be described in brief based on the above detailed description.

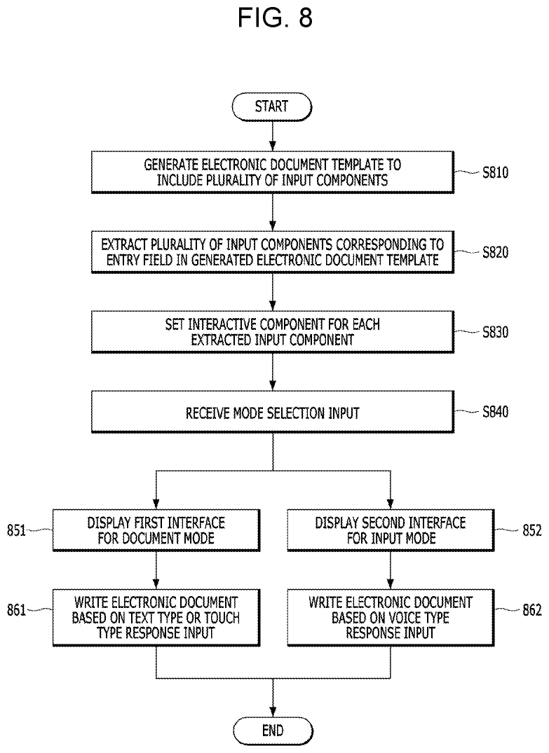

FIG. 8 is an operation flowchart of an interactive type and document type electronic document writing method according to an exemplary embodiment of the present disclosure.

The interactive type and document type electronic document writing method illustrated in FIG. 8 may be performed by the electronic document writing apparatus 100 which has described above. Therefore, even though some contents are omitted, the contents which have been described for the electronic document writing apparatus 100 may be applied to the description of the interactive type and document type electronic document writing method in the same manner.

Referring to FIG. 8, in step S810, the form generating unit 150 may generate an electronic document template to include a plurality of input components.

Next, in step S820, the component extracting unit 110 may extract a plurality of input components corresponding to each entry field in the previously generated electronic document template (for example, the electronic document template generated in step S810).

Next, in step S830, the conversation setting unit 120 may set an interactive component for each of the extracted input components.

Next, in step S840, the user input receiving unit (not illustrated) may receive a mode selection input from the user terminal 30.

Next, in step S851, when the mode selection input for the document mode is received, the display unit 130 may display the first interface in which an electronic document template is embodied, on the user terminal 30. In contrast, in step S852, when the mode selection input for the input mode is received, the display unit 130 may display the second interface for receiving a response input associated with the interactive component, on the user terminal 30.

In summary, in step S851 or S852, the display unit 130 may display an interface for any one of electronic document input modes including a document mode providing an electronic document template and an input mode providing an interactive component on the user terminal 30.

Next, in step S681, when the current electronic document input mode is a document mode, the document writing unit 140 may write the electronic document on the first interface based on the text type or the touch type response input. In contrast, when the current electronic document input mode is an input mode, in step S862, the document writing unit 140 may write the electronic document on the second interface based on the voice type response input.

Further, even though it is not illustrated in the drawings, according to the exemplary embodiment of the present disclosure, in step S861, when the mode switching input to switch an electronic document input mode is received by the user input receiving unit (not illustrated), the electronic document writing apparatus 100 may switch the electronic document input mode to the input mode. Likewise, in step S862, when the mode switching input to switch an electronic document input mode is received by the user input receiving unit (not illustrated), the electronic document writing apparatus 100 may switch the electronic document input mode to the document mode.

In the above-description, steps S810 to S862 may be further divided into additional steps or combined as smaller steps depending on an implementation example of the present disclosure. Further, some steps may be omitted if necessary and the order of steps may be changed.

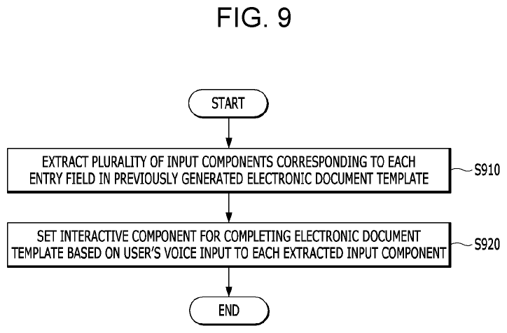

FIG. 9 is an operation flowchart of a method for providing an electronic document which is written in an interactive type according to an exemplary embodiment of the present disclosure.

The method for providing an electronic document which is written in an interactive type illustrated in FIG. 9 may be performed by the electronic document writing apparatus 100 which has described above. Therefore, even though some contents are omitted, the contents which have been described for the electronic document writing apparatus 100 may be applied to the description of the method for providing an electronic document which is written in an input mode in the same manner.

Referring to FIG. 9, in step S910, the component extracting unit 110 may extract a plurality of input components corresponding to entry fields in the previously generated electronic document template.

Next, in step S920, the conversation setting unit 120 may set an interactive component for completing an electronic document template based on a voice input of the user for each of extracted input components.

In the above-description, steps S910 and S920 may be further divided into additional steps or combined as smaller steps depending on an implementation example of the present disclosure. Further, some steps may be omitted if necessary and the order of steps may be changed.

The interactive type and document type electronic document writing method and a method for providing an electronic document which is written in an input mode according to the exemplary embodiment of the present invention may be implemented as a program command which may be executed by various computers to be recorded in a computer readable medium. The computer readable medium may include solely a program command, a data file, and a data structure or a combination thereof. The program instruction recorded in the medium may be specifically designed or constructed for the present disclosure or known to those skilled in the art of a computer software to be used. An example of the computer readable recording medium includes a magnetic media, such as a hard disk, a floppy disk, and a magnetic tape, an optical media, such as a CD-ROM and a DVD, a magneto-optical media, such as a floptical disk, and a hardware device, such as a ROM, a RAM, a flash memory, specially formed to store and execute a program command. Examples of the program command include not only a machine language code which is created by a compiler but also a high level language code which may be executed by a computer using an interpreter. The hardware device may operate as one or more software modules in order to perform the operation of the present disclosure and vice versa.

Further, the interactive type and document type electronic document writing method and a method for providing an electronic document which is written in an input mode described above may be implemented as a computer program or an application which is executed by a computer and stored in a recording medium.

The above-description of the present disclosure is illustrative only and it is understood by those skilled in the art that the present disclosure may be easily modified to another specific type without changing the technical spirit of an essential feature of the present disclosure. Thus, it is to be appreciated that the embodiments described above are intended to be illustrative in every sense, and not restrictive. For example, each component which is described as a singular form may be divided to be implemented and similarly, components which are described as a divided form may be combined to be implemented.

The scope of the present disclosure is represented by the claims to be described below rather than the detailed description, and it is to be interpreted that the meaning and scope of the claims and all the changes or modified forms derived from the equivalents thereof come within the scope of the present disclosure.

What is claimed is:

1. An interactive type and document type electronic document writing method, comprising:
extracting a plurality of input components corresponding to each entry field in a previously generated electronic document template;
setting an interactive component for each of the extracted input components; and
displaying an interface for any one of electronic document input modes including a document mode providing the electronic document template and an input mode providing the interactive component on a user terminal.

2. The interactive type and document type electronic document writing method according to claim 1, wherein the displaying includes:
displaying a first interface in which the electronic document template is embodied on the user terminal when a mode selection input for the document mode is received; and
displaying a second interface to receive a response input associated with the interactive component on the user terminal when a mode selection input for the input mode is received.

3. The interactive type and document type electronic document writing method according to claim 2, further comprising:
writing an electronic document on the first interface based on a text type or a touch type response input; and
writing an electronic document on the second interface based on a voice type response input.

4. The interactive type and document type electronic document writing method according to claim 2, further comprising:
receiving a mode switching input to switch the electronic document input mode,
wherein in the document mode, when the mode switching input is received, the electronic document input mode is switched to the input mode and in the input mode, when the mode switching input is received, the electronic document input mode is switched to the document mode.

5. The interactive type and document type electronic document writing method according to claim 3, wherein the setting of an interactive component includes:
setting a layered structure for the plurality of input components;
setting an entry order for each of the input components; and
generating a question for each of the extracted input components.

6. The interactive type and document type electronic document writing method according to claim 5, wherein the writing of the electronic document on the second interface includes:
outputting the question generated for each of the input components; and
receiving the response input for the question and extracting and entering content data corresponding to the entry field based on the response input.

7. The interactive type and document type electronic document writing method according to claim 6, wherein in the outputting of the question, a plurality of questions for each of the input components is sequentially output based on the entry order.

8. The interactive type and document type electronic document writing method according to claim 5, wherein the setting of an interactive component further includes:
setting a guidance which is displayed as a text type on the second interface.

9. The interactive type and document type electronic document writing method according to claim 6, wherein the generating of the question includes:
setting a synonym condition to extract the content data common to a plurality of phrases included in the response input; and
setting a re-question condition to provide a re-question when the response input does not satisfy a predetermined condition.

10. The interactive type and document type electronic document writing method according to claim 1, further comprising:
generating the electronic document template to include a plurality of input components.

11. A method for providing an electronic document which is written in an input mode, comprising:
extracting a plurality of input components corresponding to each entry field in a previously generated electronic document template; and
setting an interactive component to complete the electronic document template based on user's voice input to each of the extracted input components.

12. An interactive type and document type electronic document writing apparatus, comprising:
a component extracting unit configured to extract a plurality of input components corresponding to each entry field in a previously generated electronic document template;
a conversation setting unit configured to set an interactive component for each of the extracted input components; and
a display unit configured to display an interface for any one of electronic document input modes including a document mode providing the electronic document template and an input mode providing the interactive component.

13. The interactive type and document type electronic document writing apparatus according to claim 12, wherein the display unit displays a first interface in which the electronic document template is embodied when a mode selection input for the document mode is received and displays a second interface to receive a response input associated with the interactive component when a mode selection input for the input mode is received.

14. The interactive type and document type electronic document writing apparatus according to claim 13, further comprising:
a document writing unit configured to write an electronic document on the first interface based on a text type or a touch type response input or write an electronic document on the second interface based on a voice type response input.

15. The interactive type and document type electronic document writing apparatus according to claim 13, wherein the conversation setting unit includes:
an aligning unit configured to set a layered structure for the plurality of input components and set an entry order for each of the input component; and
a question generating unit configured to generate a question for each of the extracted input components.

16. The interactive type and document type electronic document writing apparatus according to claim 15, wherein the conversation setting unit further includes:
a condition setting unit configured to set a synonym condition to extract common content data for a plurality of phrases included in the response input and set a re-question condition to provide a re-question when the response input does not satisfy a predetermined condition.

17. The interactive type and document type electronic document writing apparatus according to claim 12, further comprising:
a form generating unit configured to generate the electronic document template to include a plurality of input components.
